(19) United States
(12) Patent Application Publication
(10) Pub. No.: US 2011/0153383 A1
(43) Pub. Date: Jun. 23, 2011

(54) SYSTEM AND METHOD FOR DISTRIBUTED ELICITATION AND AGGREGATION OF RISK INFORMATION

(75) Inventors: Debarun Bhattacharjya, Yorktown Heights, NY (US); Lea A. Deleris, Yorktown Heights, NY (US); Andre Elisseeff, Basel (CH); Shubir Kapoor, Yorktown Heights, NY (US); Eleni Pratsini, Rueschlikon (CH); Bonnie K. Ray, Yorktown Heights, NY (US); Wititchai Sachchamarga, Bangkok (TH)

(73) Assignee: INTERNATIONAL BUSINESS MACHINES CORPORATION, Armonk, NY (US)

(21) Appl. No.: 12/640,082

(22) Filed: Dec. 17, 2009

(51) Int. Cl. G06Q 10/00; G06N 5/02

(52) U.S. Cl. 705/7.28; 706/52; 705/348

(57) ABSTRACT

A method and system for the distributed elicitation and aggregation of risk information is provided. The method comprises selecting a risk network, the risk network comprising one or more risk nodes having associated risk information; assigning a role to each risk node, said role indicating a type of user to evaluate the risk node; generating a customized survey to elicit risk information for a risk node based upon the role and the user, wherein an order of questions in the customized survey presented to the user is determined by an ordering criteria; publishing the customized survey to the user; collecting risk information for the risk node from the user's answers to the customized survey; and populating the risk nodes based on the collected risk information.

### BACKGROUND

The present invention relates generally to risk management and, particularly to a method and system distributed elicitation and aggregation of risk information.

Organizations are increasingly aware of the need to manage risks and uncertainties affecting enterprises through risk management solutions. Modern business processes and systems are very complex and constantly growing; even seemingly local events may have global impacts. Additionally, organizations face an increase in government requirements and regulations to demonstrate a willingness to manage these risks responsibly.

Risks can be assessed and quantified using a risk model. Risk assessment utilizes estimates of the likelihood of risk events and risk impacts, in form of probabilistic statements. For example, risk assessment could be used to analyze the likelihood of a hacker gaining access to an organization's computer network. Risk assessment could be further used to estimate the cost associated with such a security breach. The probabilistic statements are obtained from data analysis, when historical data is available, and also from expert opinion, when historical data is deemed not relevant or unavailable.

Elicitation of an expert opinion is very time consuming. Further, current methods for eliciting an expert opinion are static, in that these methods do not allow the questions posed to the expert to adapt to user responses. The elicitation process may also require significant guidance, such as face-to-face workshops or phone discussions guided by a risk analyst. Further, the elicitation process is not collaborative. Multiple experts may provide inconsistent or conflicting opinions with regards to assessment of a particular risk that need to be resolved by the analyst or decision maker to make the best of the information gathered.

Thus, there is a need in the art for an improved method and system that elicits expert opinion and is adaptable based upon the information provided by the expert. Further, the method and system may be adaptable based upon the information provided by the expert and also capable of managing inconsistent or conflicting expert opinions.

### SUMMARY

A method and system for eliciting and aggregating risk information from one or several experts is disclosed. In one embodiment, the method comprises selecting a risk network, the risk network comprising one or more risk nodes having associated risk information; assigning a role to each risk node, said role indicating a type of user to evaluate the risk node; generating a customized survey to elicit risk information for a risk node based upon the role and the user, wherein an order of questions in the customized survey presented to the user is determined by an ordering criteria; publishing the customized survey to the user; collecting risk information for the risk node from the user's answers to the customized survey; and populating the risk nodes based on the collected risk information.

In one embodiment, the system comprises a processor operable to specify a risk model, the risk model comprising one or more risk nodes, assign a role to each risk node, assign an user to evaluate each risk node, generate a customized survey based upon the role and the user, publish the customized survey to the user, collect results of the customized survey from the user, and generate a risk analysis report based on the collected results.

A program storage device readable by a machine, tangibly embodying a program of instructions executable by the machine to perform above-method steps for identifying and quantifying a risk is also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an example of a method for building a risk network;

FIG. 2 is an example of a structure of the risk network;

FIG. 3 is an example of probability condition tables associated with the risk network;

FIG. 4 is an example of a survey for eliciting risk information;

FIG. 5 is an example of a risk network that can benefit from the present invention;

FIG. 6 is an example of a method for generating a survey to elicit risk information; and

FIG. 7 is an example of an architecture that may benefit from the present invention.

### DETAILED DESCRIPTION

A method and system for eliciting and aggregating risk information from an expert is disclosed. In one embodiment, the method comprises selecting a risk model, the risk model comprising one or more risk nodes, assigning a role to each risk node, assigning an user to evaluate each risk node, generating a customized survey based upon the role and the user, publishing the customized survey to the user, collecting results of the customized survey from the user, and generating a risk analysis report based on the collected results.

The following example applies the method and system eliciting and aggregating risk information in the context of quantifying customer satisfaction. In the following examples, “elicitation of risk information” and “eliciting risk information” from an expert is achieved by questioning the expert about a risk event. An expert is a person who has a special skill, knowledge or experience in a particular field. The expert supplies a probability that the risk event will or will not occur based upon his experience, expertise, and personal knowledge. The supplied probabilities (termed parameters of the conditional probability table) characterize the risk variables, which are also known in the art as risk nodes. Risk variables and risk nodes are often used interchangeably, and for the present application it is understood they are one in the same. There are occasions when a subset of risk variables taken from a larger set of risk variables is more important than the entire set of risk variables in the evaluation of a risk event. The subset of risk variables are sometimes known as variables-of-interest.

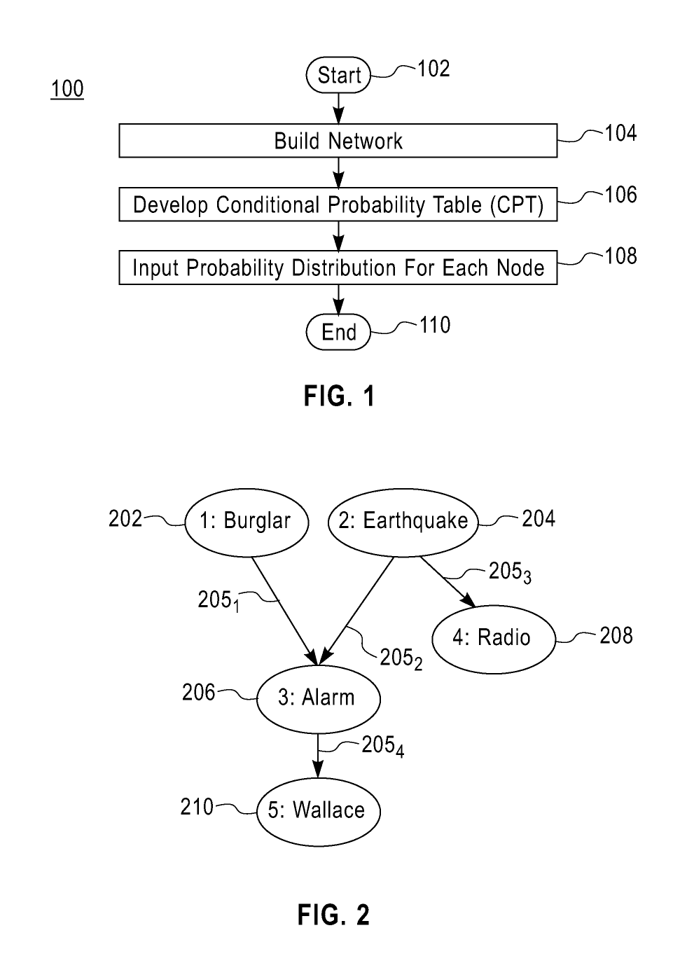

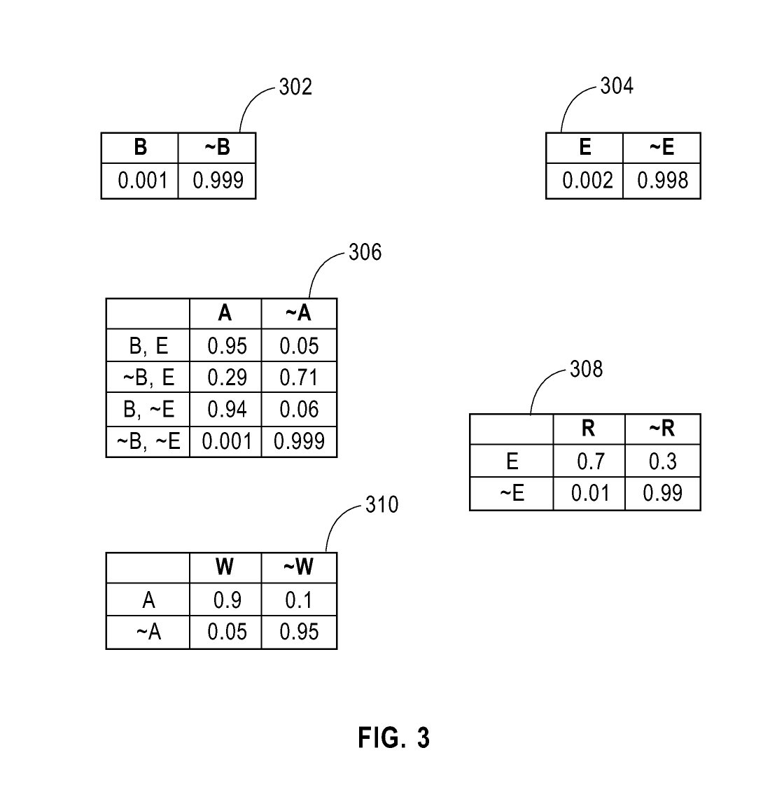

FIGS. 1, 2, and 3 taken together illustrate one example of how a Bayesian network 200 may be utilized to compose a risk network. The Bayesian network 200 comprises risk nodes 202, 204, 206, 208, and 210 and arcs 205. A Bayesian network, such as the one shown in FIG. 2, represents a joint probability distribution over a set of risk nodes. The joint distribution of the risk nodes can be used to calculate Bayesian inferences, which are often the desired outputs of the risk network.

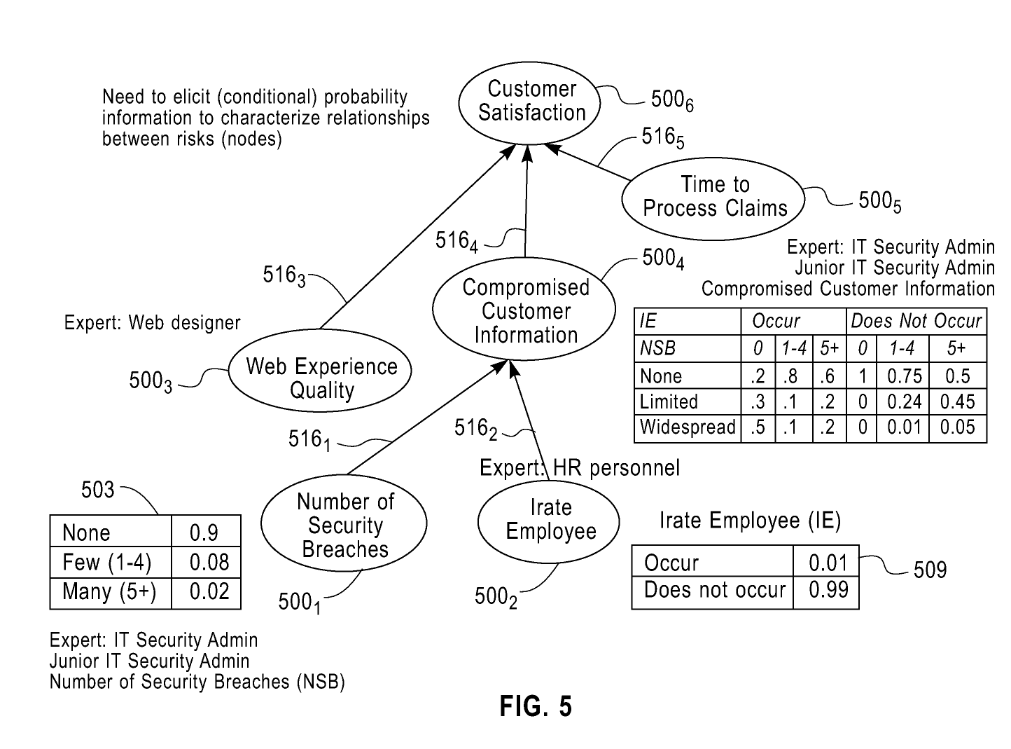

FIG. 1 is a method that may be used to build the Bayesian network 200 shown in FIG. 2. The method begins at block 102, and proceeds to block 104. At block 104, a network builder associates each risk node to one or more risk nodes in the Bayesian network 200 on the basis of a direct effect of a given risk node on a target node. The network builder is usually an expert or person who understands how the risk nodes are associated with each other. Examples of risk networks that may be created by the method of FIG. 1 are shown in FIGS. 2 and 5.

Referring to FIG. 2, an example risk network “build” is shown to include: a risk node “Alarm” 206 associated with risk node “Burglar” 202 by arc 205₁; risk node “Alarm” 206 also associated with risk node “Earthquake” 204 by arc 205₂. The presence of an arc 205 indicates a risk node has an influence upon a target risk node. For example, risk node “Burglar” 202 provides an input to target risk node “Alarm” 206, thus the output of risk node “Alarm” 206 is conditionally dependent upon the input of risk node “Burglar” 202. The absence of an arc 205 between risk nodes indicates the risk nodes are conditionally independent from each other.

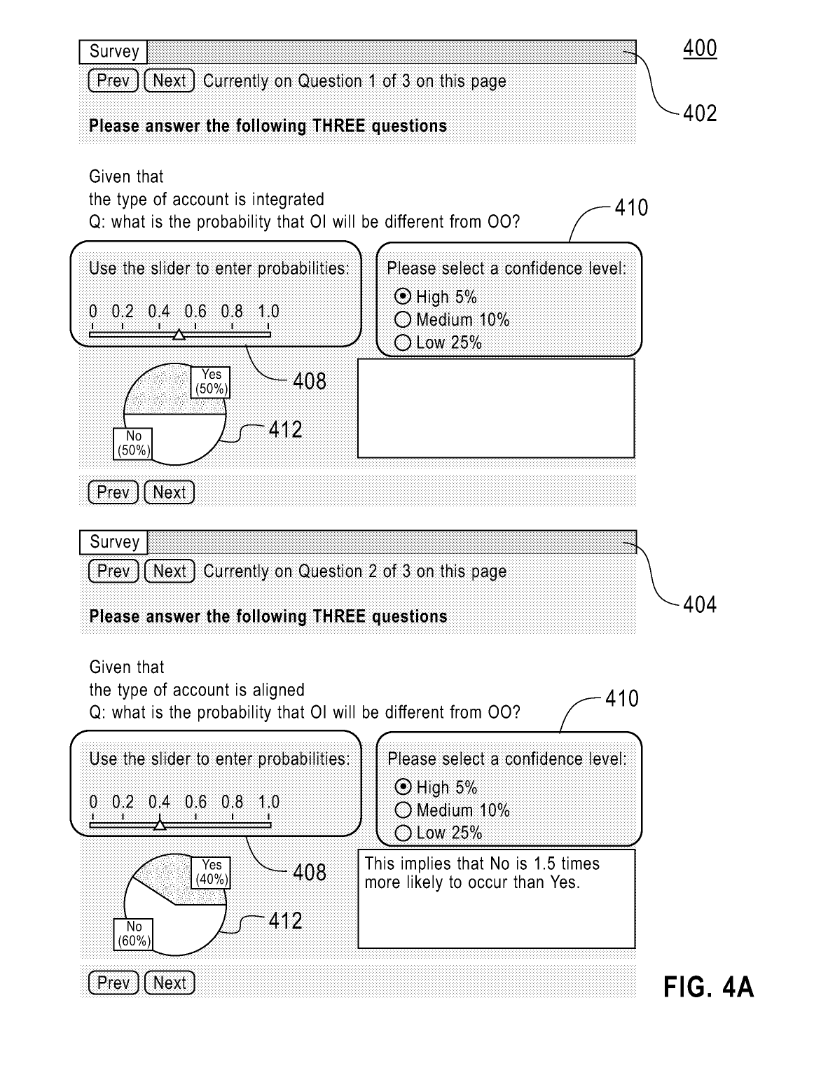

Referring back to FIG. 1, at block 106, a conditional probability table (CPT), as shown in FIG. 3, for each risk node in the Bayesian network 200 is generated based upon the conditional dependencies of each risk node.

FIG. 3 is a collection of conditional probability tables 302, 304, 306, 308, 310. Further to the example risk network 200 of FIG. 2, CPT 302 is associated with risk node 202, CPT 304 is associated with risk node 204, CPT 306 is associated with risk node 206, CPT 308 is associated with risk node 208, and CPT 310 is associated with risk node 210. The sum of all the probabilities for each row of the CPT must total to 1, as each row of the CPT provides the probability of the states of the associated risk node conditioned on the states of its parents in the network (risk nodes which have an arc going into that risk node). For example, risk node “Alarm” 206 has two parents risk node “Burglar” 202 and risk node “Earthquake” 204. Therefore, the probability of a risk event occurring at risk node “Alarm” 206 is directly dependent upon the state of risk node “Burglar” 202 and of risk node “Earthquake” 204. Mathematically, there are four possible combinations of the states of “Burglar” and “Earthquake” (shown as table 306) that can influence risk node “Alarm” 206: B & E, B & ˜E, ˜B & E, and ˜B & ˜E. The probabilities associated with the four possible combinations of “B” and “E” sum to 1.

Referring back to FIG. 1, after developing the CPT, at block 108, an expert inputs a probability value for each entry in the CPT. The expert is generally an expert on the risk associated with a particular risk node, and may also be the same as the network builder. The collection of expert opinions for each risk node in the Bayesian network 200 may be time consuming a process. Further, the number of parameters underlying a Bayesian network grows exponentially as the number of risk nodes increases. The method ends at block 110.

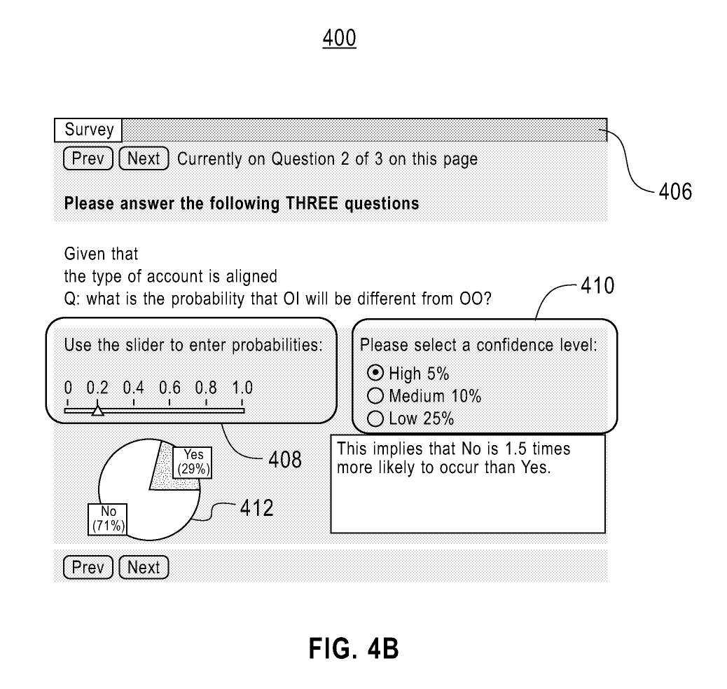

The present invention utilizes a novel system and method for eliciting information from an expert. The method efficiently gathers information from experts about various risk nodes, and the elicited information can be used in a Bayesian network, such as the one shown in FIG. 2, to evaluate risk. In one embodiment, expert opinion is collected through a series of computer-generated surveys. A survey or questionnaire, such as shown in FIG. 4, is generated for each risk node and presented to an expert. The survey elicits expert opinion about a risk event associated with a particular risk node. For example, a risk node “earthquake” is associated with the risk event earthquakes. A survey presented to an expert in the field of earthquakes, i.e., a seismologist, may ask such questions as “What is the probability of an earthquake occurring in a city next year?” “How many earthquakes do you believe will occur in a geographic location next year?” and “How confident are you in your prediction that an earthquake will occur in a city next year?” In the present example, the answers or inputs to the survey questions are discrete values such as “5” and probabilistic values such as “10%” or “0.1”. However, it is understood that non-numerical answers to survey questions such as “yes” or “no” are also possible.

In one embodiment, the surveys are generated in accordance with the “Triple-S Survey Standard.” A complete description of the Triple-S Survey Standard is maintained at http://www.triple-s.org. The Triple-S survey standard facilitates the transfer of data and metadata between survey software packages. The standard defines two text files, a “definition file” and a “data file” that describe the survey data. The “definition file” includes general information about the survey and descriptions of the survey variables, such as, for example, variable metadata. The definition file is coded in XML syntax according to rules provided by the associated Triple-S XML Document Type Definition (DTD). The data file contains the actual case data for the survey.

FIG. 4 is an example of a survey 400 for presentation to a user on a client computing device generated in accordance with the present invention. In one embodiment, the survey is a series of questions and answers that pertain to a risk node. The structure of the survey is based on pre-defined templates that are applied to the question and answer choices during the survey generation process. The survey templates govern the amount and specificity of information collected for each question.

The survey 400 comprises three different questions 402, 404 and 406 presented via GUI (e.g., web browser) on the client computing device. A “slider” 408 is manipulated by the expert answering the survey questions to select a probability value between 0 and 1. The expert is also able to select a “confidence level” 410 associated with the probability value via the GUI. Based on the expert's responses, a “probability wheel” 412 is generated that indicates to the expert the probability distribution of the selected probability in relation to the other possible answer choices. Other questions formats (such as deterministic questions) and other screen snapshots representing summaries of the answer provided so far can be included in the survey whenever relevant.

In one embodiment, survey questions are presented to an expert in a predefined order, such as a sequential order. In another embodiment, the most important survey questions are presented to the expert at the beginning of the survey. In yet another embodiment, the survey questions are presented to the expert in a dynamic order, i.e., the response to one survey question influences which survey question will be presented next. The order of the questions is important because an expert may not answer every single question in a survey. The order of the questions is also important because certain questions may be more pertinent to evaluating a risk node. The information elicited from the most pertinent questions are sometimes known as “variables-of-interest.”

The expert opinions may be elicited through the use of a survey presented via a GUI, such as the one shown in FIG. 4. Failure of an expert to provide a probability value for each variable in the Bayesian network, i.e., incomplete elicitation of each risk node in the network, may result in a distribution that is different from the actual joint distribution. An inaccurate distribution of variables may lead to inaccurate inferences. Therefore, an incomplete elicitation may result in a joint distribution that is approximate to the actual joint distribution over the elicited variables.

In an alternate embodiment, only a portion of the Bayesian network 200 is under evaluation. Therefore, only the variables relevant to the variables-of-interest need to be evaluated. However, an expert may fail to provide a value for each variable. In this instance, such an incomplete elicitation may result in a joint distribution that is approximate to the actual joint distribution over the variable-of-interest variables.

In one embodiment, the selection of the risk node selected for elicitation is based upon a criteria that captures some measure of informativeness of a partially elicited risk network, as specified in the following equation:

i*=argmin_{i∈K}E[D(P_{Z},Q_{Z}^{i∪K})] (1)

where
K denotes the set of risk nodes that has been elicited so far (It can be the empty set)
P_{Z} denote the true probability joint distribution of over the set of variables-of-interest Z
Q_{Z}^{K} denotes the joint distribution that would be used if only the variables in the set K had been elicited.
i indexes risk nodes
E indicates the expectation operator
D is a distance metric between two probability distributions

Given a set of already elicited nodes K, the selected node i* is the node that minimizes the expected distance between the true joint distribution and the approximate joint distribution that is used once that node is elicited. There are several distance metrics that can be used for D, such as the Euclidean distance, the total variation, and the Kuilback-Leibler divergence.

In the one embodiment, the i* node selected is the node with the shortest Euclidean distance between the joint distributions of P_{Z} and Q_{Z}^{i∪K}. In another embodiment, the square of the Euclidean distance is used to select the i* node. After elicitation of the i* node, the set K is updated to include the node i*.

In one embodiment, if nodes in K are elicited, then the i node selected for elicitation is selected according to equation 2:

$$E [ D ( {P}_{Z} , {Q}_{Z}^{i ⋃ κ} ) ] \approx {\sum }_{z} [ ( {μ}_{{x}_{i} \vert {u}_{i}^{2}} + {σ}_{{x}_{i} \vert {u}_{i}^{2}} ) ( {\prod }_{j ∈ κ} {θ}_{{x}_{j} \vert {u}_{j}^{2}} ) ( {\prod }_{j \neq i ; j ∉ κ} {μ}_{{x}_{j} \vert {u}_{j}^{2}} ) ( {\sum }_{j \neq i ; j ∉ κ} \frac{{σ}_{{x}_{j} \vert {u}_{j}^{{2}^{2}}}}{{μ}_{{x}_{j} \vert {u}_{j}}} ) ] \qquad ( 2 )$$

where
K denotes the set of risk nodes that has been elicited so far (It can be the empty set)
θₓ_{ⱼ}ᵤ_{ⱼ} denotes the true value of the parameter for node j given the states of its parents defined by μⱼ.
μₓ_{ⱼ}_{|u}_{ⱼ} denotes the expected value of the parameter for node j given the states of its parents defined by μⱼ.
σₓ_{ⱼ}_{|u}_{ⱼ} denotes the standard deviation of the parameter for node j given the states of its parents defined by μⱼ.
E indicates the expectation operator

Selecting a risk node for elicitation according to equation 2 may be computationally intensive for a large Bayesian network. However, Bayesian networks composed of risk nodes elicited from experts tend to be small.

In another embodiment, the i node selected for elicitation is selected according to the number of states “s” for the non-elicited nodes remaining in the Bayesian network according to equation 3:

$$E [ D ( {P}_{Z} , {Q}_{Z}^{i ⋃ κ} ) ] \approx C ( κ ) ( \frac{{s}_{i}}{{s}_{i} + 1} ) ( ( {\sum }_{j ∉ κ} \frac{{s}_{j} - 1}{{s}_{j} + 1} ) - ( \frac{{s}_{i} - 1}{{s}_{i} + 1} ) ) \qquad ( 3 )$$

where
K denotes the set of risk nodes that has been elicited so far (It can be the empty set)
sⱼ denotes the number of states of node j
   where C(K) is a function of the elicited nodes and the rest of the formula depends only on the number of states, s, of non-elicited nodes in the Bayesian network. For example, consider the Bayesian network 200, as shown in FIG. 2. This particular Bayesian network 200 is also known in the literature as the “Burglar Network.” Assume the “Burglar Network” comprises nodes 202, 204, 206, 208, and 210 which respectively have a number of states (s) 3, 4, 5, 6 and 7. When the order of elicitation of nodes is computed according to equation 3, the order of elicitation is 202, 204, 208, 210 and 206. When none of the nodes have been elicited, node 202 is selected first because it has the minimum number of states, i.e., 3.

The nodes are selected because their proximity to the joint distribution of the Bayesian network makes a tradeoff between the “spread” in the selected node and the “spread” from the combination of non-elicited nodes. The selection of the node with the minimum or maximum number of states is determined by the degree to which selection of the node will reduce the spread.

In one embodiment, a Monte Carlo simulation is used to select the next node i to elicit. Given a Bayesian network with known variables Z, states and structure, variables-of-interest Y, prior distributions on all parameters, and all parameters for CPTs of elicited nodes in set k, the next node i to elicit (i*∉K) from the expert is selected according to the steps as follows:
1. Using the exact values of the parameters for nodes i∈K and a sample point generated from the prior distribution of all parameters for all nodes i∉K , generate a sample point for the actual joint distribution of Z, P_{Z}.
2. Denote by Q_{Z}^{i∪K} the partial assessment joint distribution of Z when node i is elicited, where parameters for node i are the values generated from P_{Z}, parameters for nodes i∈K are the expected values of the priors, and the parameters for nodes i∈K are the actual numbers already elicited.
3. Find the joint distributions of the variables-of-interest P_{Y} and Q_{Y}^{i∪K}∀i, using inference if required.
4. Find D(P_{Y},Q_{Y}^{i∪K})∀i.
5. Repeat Steps 1-3 n times. Use the average value of the n distances to estimate E[D(P_{Y},Q_{Y}^{iUK})].
6. Based on the obtained average values, choose the next node to elicit and add i*=argrmin_{i∉K}E[D(P_{Z},Q_{Z}^{i∪K})] and i* to K.

7. Repeat steps 1 to 6 to find the next node to elicit.

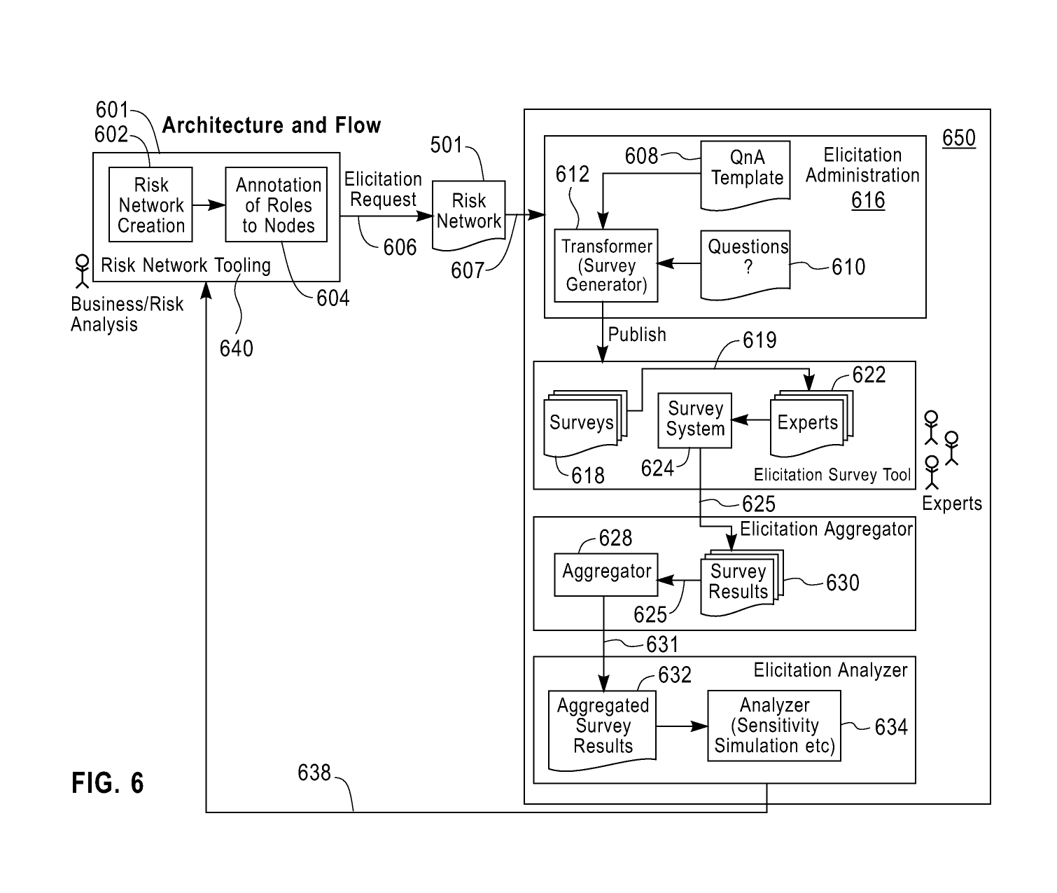

FIGS. 5 and 6, taken together, are an example of how a risk network can benefit from the method of the present invention. FIG. 5 is another example of a risk network (structured as a Bayesian network) 501. The risk network 501 comprises risk nodes 500. The risk nodes, 500₁ to 500₆, are directly or indirectly interconnected with each other by arcs 516, and each risk node 500 is associated with a set of possible risk models.

The outputs of each risk node in the network are capable of functioning as inputs to another risk node. In one embodiment, the outputs of each risk model are a probabilistic distribution of an occurrence of a risk event for each risk node. The form of the outputs is consistent across the composite risk model network, and each risk node that relies on a parent risk node is consistent with the parent risk node. This consistency allows the outputs of different risk models to be combined.

Expert opinion for each risk node can be elicited and aggregated by the present invention as described below and further shown in FIG. 6. In one embodiment, the results of the expert evaluation are stored in a table. As an example, the expert evaluation of NSB risk node 500₁ is stored in table 503 and the expert evaluation of IE risk node 500₂ is stored in table 509. In this example, both tables 503 and 509 store the results of the expert evaluation as a probabilistic distribution of a risk event.

FIG. 6 is a flow diagram of a method for eliciting and aggregating expert opinion in accordance with one embodiment of the present invention. The method begins at step 602, when the “risk network tooling” 656 is used to provide or otherwise create a risk network. One possible method for an expert to create the risk network is shown in FIG. 1. Referring back to FIG. 6, at step 604, expert roles are assigned to the individual risk nodes in the risk network. The role indicates which type of expert is capable to evaluate the risk node. For example, referring back to FIG. 5, a computer security expert could be assigned to evaluate risk node 500₁ and a human resources expert assigned to evaluate risk node 500₂. In one embodiment, the assigning of expert roles to individual nodes is done by the creator of the risk network. In another embodiment, software matches the risk node to an expert.

At step 606, an elicitation request is communicated to the risk network 501, e.g., via HTTP, initiating evaluation of all the risk nodes 500. At step 607, the elicitation request is passed on to an “elicitation administration” module 616. The “elicitation administration” module 616 generates surveys 618 that are published to the experts. As discussed above, in one embodiment, the surveys are generated in accordance with the “Triple-S Survey Standard.” A “survey generator” 612 combines a “question and answer template” 608 with “questions” 610 to generate a survey 618. In one embodiment, that survey complies with the “Triple-S Survey Standard.” The “questions” 610 are stored in a TRIPLE-S compliant data file as discussed above. An example of a survey that may be generated in accordance with the present invention is provided in FIG. 4.

The surveys 618 are published to one or more experts at step 619. An “elicitation survey module” 624 publishes an appropriate survey to the expert assigned to a particular risk node at step 604. For example, the “elicitation survey tool” 624 presents a computer security expert with a survey designed to evaluate risk node 500₁ In one embodiment, the “elicitation survey tool” 624 publishes the survey to the expert via e-mail. The survey 618 may also be communicated to the expert in other ways. The expert receives an e-mail containing a hyperlink or universal resource locator (URL) that links to an online version of the survey. Once the online survey 618 is completed by the expert, the “survey results” 630 are communicated to an “elicitation aggregator” 628 at step 625.

The “elicitation aggregator” module 628 aggregates the expert opinions for each individual risk node. In one embodiment, the expert opinions are aggregated on the basis of the confidence levels assigned to each expert opinion. For example, an expert who is “highly confident” in his opinion will receive a greater weight for his opinion in the aggregation. In another embodiment, a greater weight is given to experts who are deemed influential through peer review. As one example, experts may be asked to rate the other experts in their field, and the most highly rated expert would be considered the most influential expert. As another example, the expert with the greatest frequency of citations in journal articles related to his field could be considered the most influential expert. Peer review may also be based upon an expert's answers in other assessment exercises. In one embodiment, the expert's timeliness of answers and credibility may be used as evaluation criteria.

Referring back to FIG. 5 as an example, risk node 500₁ may be evaluated by both a senior computer security expert and a junior computer security expert. In the present example, it would be more desirable to weight the expert opinion of a senior computer security expert greater than the expert opinion of a junior computer security expert. Aggregation and weighting rules for expert opinions have received ample review in the decision analysis literature. As can be determined by someone skilled in the art, the present invention can apply any of such methods and rules.

In one embodiment, “elicitation aggregator” module 628 checks for consistency among the collected expert opinions. If the answers, i.e., the probabilities supplied by the experts, differ beyond a threshold value, then additional information may be collected from the experts. For example, if two different experts were polled on the probability of rain occurring the next day, and one expert answered with a 0% probability of rain occurring, while the other expert answered with a 100% probability of rain occurring, the “elicitation analyzer” 634 would note that these answers are inconsistent with each other. In one embodiment, consistency between answers is measured by probabilities supplied by an expert not deviating beyond a threshold value. The threshold value may be set by the user requesting the risk analysis or the risk network builder.

In another embodiment, the “elicitation aggregator” module 628 checks for possible inconsistencies among the experts answers. For example, if the senior and junior computer security expert evaluate risk node 500₁ and their opinions conflict on the probability of a security breach, the “elicitation aggregator” module 634 may further query the experts providing the expert opinion for a confidence level on their opinion. In another embodiment, the “elicitation aggregator” 628 may also determine if a minimum number of questions were answered in a survey by the expert to properly quantify the risk for a particular risk node. If enough questions were not answered by the expert, then the “elicitation aggregator” 628 may query the expert with additional questions, or elicit risk information from additional experts. In one embodiment, the “elicitation aggregator” 628 would require at least one high confidence answer from one of the experts to be able to assign a value to the risk node. In another embodiment, regardless of expert confidence, experts answer would be aggregated following a linear pool or a logarithmic pool with all experts having the same weight and only query for more experts if no answer is available for a given risk node.

Referring again to FIG. 6, at step 631, the “aggregated survey results” 632 are passed to an “elicitation analyzer” module 634.

In one embodiment, the “elicitation analyzer” module 634 checks for consistency among the collected expert opinions. For example, In one embodiment, consistency between answers is measured based on the difference between two experts answers on some output of the risk network (for instance, specific inference queries). If that difference is above a given threshold, experts may be asked to confirm or revise their answers. The threshold value may be set by the risk network builder.

At step 638, a risk quantification analysis is provided to the user. The risk quantification analysis is based upon evaluation of the entire risk network. A result or risk analysis report is provided to the user by the risk “elicitation analyzer” 634. The provided result may be a discrete value, a table of probability distributions, or any other output that allows the user to evaluate risk.

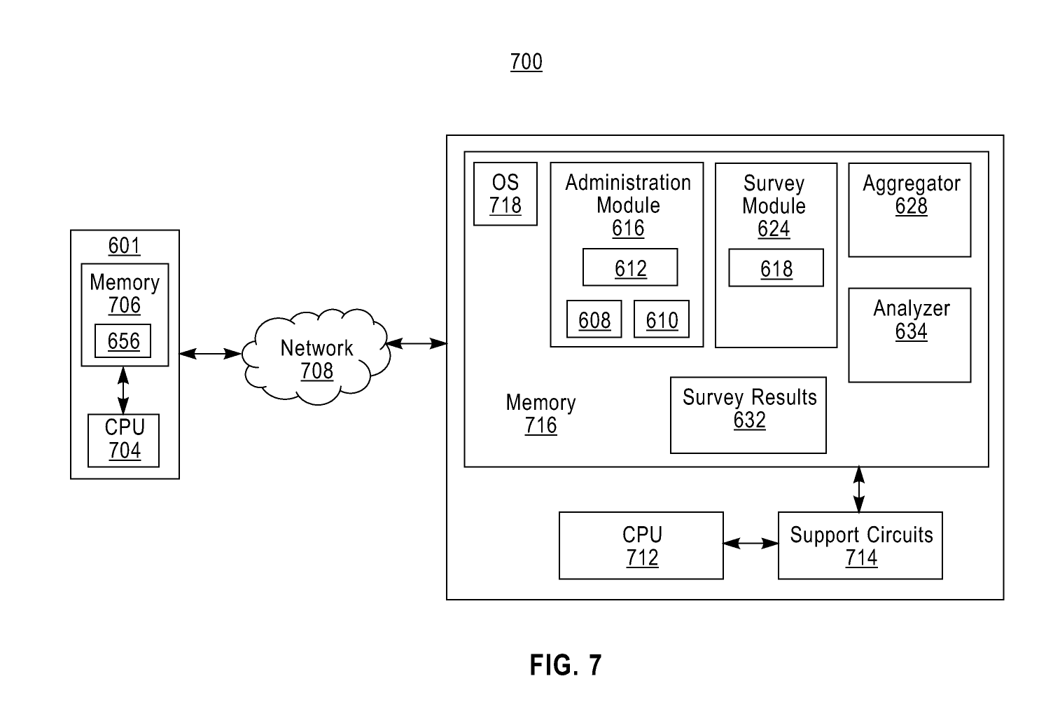

FIG. 7 is a block diagram of an architecture and computing environment 700 for implementing the present invention. The environment 700 comprises a client computer 601 connected to a risk server 650 via a network 708. The client computer 601 comprises a processor (CPU) 704 and a memory 706. The client computer 601 may be a desktop computer, laptop computer, personal digital assistant (PDA) or any device that can benefit from connection to the network 708. The network 708 may be any standard network for connecting computing devices, such as the Internet, Ethernet, public or private LAN or WAN (corporate intranet).

In one embodiment, the memory 706 of the client computer stores the “risk network tooling” 656 which is used to create the risk network and assign roles to the individual risk nodes in the risk network.

The risk server 650 comprises a processor (CPU) 712, support circuits 714, and a memory 716. The CPU 712 is interconnected to the memory 716 via the support circuits 714. The support circuits 714 includes cache, power supplies, clocks, input/output interface circuitry, and the like.

The memory 716 may include random access memory, read only memory, removable disk memory, flash memory, and various combinations of these types of memory. The memory 716 is sometimes referred to as a main memory and may in part be used as cache memory. The memory 716 stores an operating system (OS) 718, an “elicitation administration” module 616, an “elicitation survey module” 624, an aggregation module 628, an “elicitation analyzer” module 634 and survey results 632. The risk server 650 is a general computing device that becomes a specific computing device when the processor 712 operates any one of the modules 616, 624, 628 and 634.

The function of each of the modules 616, 624, 628 and 634 is discussed above with respect to the method for eliciting and aggregating expert opinion. The “elicitation administration” module 616 comprises a “survey generator” 612, “survey questions” 610 and “question and answer templates” 608. The “survey generator” 612 is responsible for generating surveys 618 from “questions” 610 and “question and answer templates” 608. The “elicitation administration” module 616 provides surveys to the “elicitation survey module” 624.

The “elicitation survey module” 624 publishes surveys 618 to experts, tracks responses to surveys, and collects “survey results” 630. The “survey results” 630 are then passed to the aggregation module 628.

The aggregation module 628 aggregates the “survey results” 630 collected from the different experts for each risk node. The aggregation module 628 may use a weighting system or a set of aggregation rules to place a greater importance on a particular expert's opinion. The “aggregated survey results” 632 are passed to the “elicitation analyzer” module 634. The “elicitation aggregator” module 628 checks for possible inconsistent answers among the experts assigned to evaluate a risk node, and if necessary elicits additional information from the experts.

The “elicitation analyzer” module 634 checks the “aggregated survey results” 632 for possible inconsistent answers among the experts assigned to evaluate a risk node, and if necessary elicits additional information from the experts.

The risk server 650 and the various modules 616, 624, 628 and 634 provides for distributed risk elicitation by publishing surveys and collecting survey answers from experts assigned to a risk node. The risk server 650 also aggregates and analyzes the collected survey answers, thus allowing risk analysis on a distributed basis.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction operation system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction operation system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may operate entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which operate via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which operate on the computer or other programmable apparatus provide processes for implementing the functions/acts specified in the flowchart and/or block diagram block or blocks.

Referring now to FIGS. 1 through 7. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be operated substantially concurrently, or the blocks may sometimes be operated in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

1. A computer implemented method for eliciting risk information, the method comprising:
selecting a risk network, the risk network comprising one or more risk nodes having associated risk information;
assigning one or more roles to each risk node, said role indicating one or more types of users to evaluate the risk node;
presenting questions to one of the users to elicit risk information;
collecting risk information for the risk nodes from the user's answers to the questions; and
populating the risk nodes based on the collected risk information.

2. The computer implemented method of claim 1, further comprising:
analyzing the collected risk information for at least one of completeness and consistency, wherein completeness is satisfied by the user answering a minimum number of questions from the presented questions and consistency is satisfied by the collected risk information not deviating by more than a specified amount from the risk information collected from another user assigned to evaluate the same risk node.

3. The computer implemented method of claim 2, further comprising:
analyzing the collected risk information to determine if additional questions need to be presented to one or more users so as to ensure that the risk information is up-to-date

4. The computer implemented method of claim 2, further comprising:
assigning a weight to the collected risk information; and
aggregating the weighted risk information with other risk information to generate enhanced risk information (either new information if there was no such information already collected or updated information if there was prior information available).

5. The computer implemented method of claim 3, wherein the weight assigned is based on a confidence level provided by the user completing the survey.

6. The computer implemented method of claim 3, wherein the weight assigned is based upon a peer review evaluation of the user, wherein peer review is based on at least one of credibility and timeliness in other risk assessment exercises.

7. The computer implemented method of claim 3, wherein the weight assigned is based upon a match between user attributes and the role.

8. The computer implemented method of claim 1, wherein the questions in the customized survey follow an ordering criteria defined by:
selecting a risk node for elicitation based upon a criteria that captures an amount of information of a partially elicited risk network, such criteria defined according to the equation: i*=argmin_{i∉K}E [D(P_{Z},Q_{Z}^{i∪K})], wherein the risk node selected minimizes an expected distance between a “true” value of a joint probability distribution of the risk network and a value of the joint probability distribution of the risk network if the selected risk node is elicited compared to all other risk nodes that have not been elicited.

9. The computer implemented method of claim 1, wherein the questions in the customized survey follow an ordering criteria defined by:
selecting a risk node for elicitation based upon the number of states associated with the risk node, wherein the risk node is a non-elicited risk node.

10. The computer implemented method of claim 1, wherein the questions in the customized survey follow an ordering criteria defined by:
selecting a risk node for elicitation based upon a Monte Carlo simulation of the risk network and it's the risk network's parameters.

11. The computer implemented method of claim 1, wherein the questions in the customized survey follow an ordering criteria defined by:
selecting a risk node for elicitation based upon minimizing a solution to an equation, the equation defined by:
$$C ( κ ) ( \frac{{s}_{i}}{{s}_{i} + 1} ) ( ( {\sum }_{j ∉ κ} \frac{{s}_{j} - 1}{{s}_{j} + 1} ) - ( \frac{{s}_{i} - 1}{{s}_{i} + 1} ) ) .$$

12. A computer program product for eliciting risk information, comprising:
a storage medium readable by a processor and storing instructions for operation by the processor for performing a method comprising:
selecting a risk network, the risk network comprising one or more risk nodes having associated risk information;
assigning one or more roles to each risk node, said role indicating one or more types of users to evaluate the risk node;
presenting questions to one of the users to elicit risk information;
collecting risk information for the risk nodes from the user's answers to the questions; and
populating the risk nodes based on the collected risk information.

13. The computer program product of claim 12, the computer program product further comprising:
analyzing the collected risk information for at least one of completeness and consistency, wherein completeness is satisfied by the user answering a minimum number of questions from the presented questions and consistency is satisfied by the collected risk information not conflicting with risk information collected from another user assigned to evaluate the same risk node.

14. The computer program product of claim 13, the computer program product further comprising assigning a weight to the collected risk information and aggregating the weighted risk information with other risk information to generate enhanced risk information.

15. The computer program product of claim 12, wherein ordering the questions in the customized survey comprises:
selecting a risk node for elicitation based upon generating a joint probability distribution that is closest in value to an expected value of the joint probability distribution of the risk network.

16. The computer program product of claim 12, wherein ordering the questions in the customized survey comprises:
selecting a risk node for elicitation based upon the number of states associated with the risk node, wherein the risk rode selected comprises the least number of states for elicitation.

17. The computer program product of claim 12, wherein ordering the questions in the customized survey comprises:
selecting a risk node for elicitation based upon a Monte Carlo simulation of the risk network and the risk network's parameters.

18. The computer program product of claim 12, wherein ordering the questions in the customized survey comprises:
selecting a risk node for elicitation based upon minimizing a solution to an equation, the equation defined by:
$$C ( κ ) ( \frac{{s}_{i}}{{s}_{i} + 1} ) ( ( {\sum }_{j ∉ κ} \frac{{s}_{j} - 1}{{s}_{j} + 1} ) - ( \frac{{s}_{i} - 1}{{s}_{i} + 1} ) ) .$$

19. The computer program product of claim 12, wherein ordering the questions in the customized survey comprises:
selecting a risk node for elicitation based upon the number of states associated with the risk node, wherein the risk node is a non-elicited risk node.

20. The computer program product of claim 12, wherein ordering the questions in the customized survey comprises:
selecting a risk node for elicitation based upon a criteria that captures an amount of information of a partially elicited risk network, such criteria defined according to the equation: i*=argmin_{i∈K}E[D(P_{Z},Q_{Z}^{i∪K})], wherein the risk node selected minimizes an expected distance between a “true” value of a joint probability distribution of the risk network and a value of the joint probability distribution of the risk network if the selected risk node is elicited compared to all other risk nodes that have not been elicited.

21. A system for eliciting risk information, the system comprising a processor operable to select a risk network, the risk network comprising one or more risk nodes having associated risk information, assign a role to each risk node, said role indicating a type of user to evaluate the risk node, present questions to the user to elicit risk information, said questions presented in accordance with an ordering criteria, collect risk information for the risk node from the user's answers to the ordered questions, and populate the risk nodes based on the collected risk information.

22. The system of claim 21 wherein the processor is further operable to analyze the collected risk information for at least one of completeness and consistency, wherein completeness is satisfied by the user answering a minimum number of questions from the presented questions and consistency is satisfied by the collected risk information not deviating by more than a specified amount from the risk information collected from another user assigned to evaluate the same risk node.

23. The system of claim 21 wherein the processor is further operable to order the questions in the customized survey by:
selecting a risk node for elicitation based upon generating a joint probability distribution that is closest in value to an expected value of the joint probability distribution of the risk network.

24. The system of claim 21 wherein the processor is further operable to order the questions in the customized survey by:
selecting a risk node for elicitation based upon the number of states associated with the risk node, wherein the risk rode selected comprises the least number of states for elicitation.

25. The system of claim 21 wherein the processor is further operable to order the questions in the customized survey by:
selecting a risk node for elicitation based upon a Monte Carlo simulation of the risk network and the risk network's parameters.
